(19) United States
(12) Patent Application Publication
(10) Pub. No.: US 2007/0001809 A1
(43) Pub. Date: Jan. 4, 2007

(54) Method and system for reading objects having radio frequency identification (RFID) tags inside enclosures

(75) Inventors: Venkata Kodukula, Bothell, WA (US); Pavel Nikitin, Seattle, WA (US)

Correspondence Address: SEED INTELLECTUAL PROPERTY LAW GROUP PLLC, 701 FIFTH AVENUE, SUITE 6300, SEATTLE, WA, 98104-7092, US

(73) Assignee: Intermec IP Corp., Woodland Hills, CA (US)

(21) Appl. No.: 11/404,510

(22) Filed: Apr. 14, 2006

Related U.S. Application Data
(60) Provisional application No. 60/676,995, filed on May 2, 2005.

(51) Int. Cl. H04Q 5/22

(52) U.S. Cl. 340/10.1; 340/572.7

(57) ABSTRACT

An automatic data collection system reads data encoded in data carriers located inside enclosed environments, such as radio frequency identification (RFID) tags attached to objects located in enclosures, such as buildings, shipping containers, transportation vehicles such as airplanes, and other enclosures. The enclosures have dimensions that normally exceed the read range of the RFID tags, and/or the enclosures are composed of a material (such as metal) that impede communication of signals with external RFID readers. Therefore, internal antenna systems are provided inside of the enclosures to relay interrogation signals from RFID readers to the RFID tags, and to relay response signals from the RFID tags back to the RFID readers.

### CROSS REFERENCE TO RELATED APPLICATION

The present application claims the benefit under 35 U.S.C. § 119(e) from U.S. Provisional Patent Application Ser. No. 60/676,995, Attorney Docket No. 38418P1, Express Mail Label No. EV372124011US, entitled “SYSTEM AND METHOD FOR READING RFID TAGS INSIDE METAL CONTAINERS,” filed May 2, 2005, with inventor Venkata S. R. Kodukula, assigned to the same assignee as the present application, and incorporated herein by reference in its entirety

### TECHNICAL FIELD

This disclosure generally relates to the field of automatic data collection (ADC), for example, data acquisition via radio frequency identification (RFID) tags and readers. More particularly but not exclusively, the present disclosure relates to providing communications between RFID tags in enclosed environments, and one or more RFID readers and associated host computing systems.

### BACKGROUND INFORMATION

The ADC field includes a variety of different types of ADC data carriers and ADC readers operable to read data encoded in such data carriers. For example, data may be encoded in machine-readable symbols, such as barcode symbols, area or matrix code symbols, and/or stack code symbols. Machine-readable symbols readers may employ a scanner and/or imager to capture the data encoded in the optical pattern of such machine-readable symbols. Other types of data carriers and associated readers exist, for example magnetic stripes, optical memory tags, and touch memories.

Other types of ADC carriers include RFID tags that may store data in a wirelessly accessible memory, and may include a discrete power source (i.e., an active RFID tag), or may rely on power derived from an interrogation signal (i.e., a passive RFID tag). RFID readers typically emit a radio frequency (RF) interrogation signal that causes the RFID tag to respond with a return RF signal encoding the data stored in the memory.

RFID tags typically include a semiconductor device having the memory, circuitry, and one or more conductive traces that form an antenna. Typically, RFID tags act as transponders, providing information stored in the semiconductor device in response to the RF interrogation signal received at the antenna from the reader or other interrogator. Some RFID tags include security measures, such as passwords and/or encryption. Many RFID tags also permit information to be written or stored in the semiconductor memory via an RF signal.

Identification of an RFID device or tag generally depends on RF energy produced by a reader or interrogator arriving at the RFID tag and returning to the reader. Multiple protocols exist for use with RFID tags. These protocols may specify, among other things, particular frequency ranges, frequency channels, modulation schemes, security schemes, and data formats.

Many ADC systems that use RFID tags employ an RFID reader in communication with one or more host computing systems that act as central depositories to store and/or process and/or share data collected by the RFID reader. In many applications, wireless communications is provided between the RFID reader and the host computing system. Wireless communications allow the RFID reader to be mobile, may lower the cost associated with installation of an ADC system, and permit flexibility in reorganizing a facility, for example a warehouse.

There are a number of common situations where the RFID tags may be located inside various enclosures. Some of these enclosures may have entirely or partially metal or metalized surfaces. Examples of enclosures include: entirely metal enclosures (e.g., shipping containers), partially metal enclosures (e.g., vehicles such as airplanes, buses, trains, and ships that have a housing made from a combination of metal and other materials), and non-metal enclosures (e.g., warehouses and buildings made of wood or sections of the buildings such as floors, rooms, and shelves). Examples of objects with RFID tags that may be located in these enclosures include: goods inside shipping containers, goods and parcels inside warehouses, inventory items inside buildings, various goods inside retail stores, and various portable items (e.g., passenger identification cards and tickets, baggage, cargo, individual life-saving equipment such as life jackets and masks) inside vehicles, and so forth.

The read range (e.g., the range of the interrogation and/or response signals) of RFID tags is limited. For example, some types of passive RFID tags have maximum range of about 40 feet, which may be attained only in ideal free space conditions with favorable antenna orientation. In a real situation, the observed tag range is often 20 feet or less. Therefore, the enclosures described above may have dimensions that far exceed the read range of an individual RFID tag, if the RFID reader cannot be placed in close proximity to a target RFID tag. Additionally, metal surfaces of the enclosures present a serious obstacle for the RF signals that need to be exchanged between RFID readers and RFID tags, making RFID tags behind those surfaces undetectable in most cases.

### BRIEF SUMMARY OF THE INVENTION

One aspect provides a system for an enclosure to contain a plurality of wireless data carriers. The system has an antenna system extended within the enclosure to send a wireless interrogation signal to and to receive corresponding wireless response signals from at least some of the data carriers that are located within a communication range from the antenna system. An automatic data collection device has an antenna that is separate and distinct from the antenna system. The data collection device is communicatively coupled to the antenna system to generate the interrogation signal sent by the antenna system and to process the response signals received by the antenna system.

### BRIEF DESCRIPTION OF THE SEVERAL VIEWS OF THE DRAWINGS

Non-limiting and non-exhaustive embodiments are described with reference to the following drawings, wherein like reference numerals refer to like parts throughout the various views unless otherwise specified. The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements as drawn, are not intended to convey any information regarding the actual shape of the particular elements, and have been solely selected for ease of recognition in the drawings.

FIG. 1 is a schematic diagram of an embodiment of a system to read RFID tags inside large enclosures.

FIG. 2 is a schematic diagram of an embodiment of a system to read RFID tags inside metal enclosures.

FIG. 3 is a schematic diagram of another embodiment of a system to read RFID tags inside metal enclosures.

FIG. 4 is a schematic diagram of an embodiment of a system to read RFID tags inside a vehicle, such as an aircraft.

FIG. 5 is a schematic diagram further illustrating the embodiment of the system of FIG. 4 to read RFID tags.

FIG. 6 is a flow diagram of an embodiment of a method to read RFID tags inside enclosures.

### DETAILED DESCRIPTION

Embodiments of techniques to read RFID tags inside enclosures are described herein. In the following description, numerous specific details are given to provide a thorough understanding of embodiments. One skilled in the relevant art will recognize, however, that the embodiments can be practiced without one or more of the specific details, or with other methods, components, materials, etc. In other instances, well-known structures, materials, or operations associated with RFID tags and RFID readers, computer and/or telecommunications networks, and/or computing systems are not shown or described in detail to avoid obscuring aspects of the embodiments.

Unless the context requires otherwise, throughout the specification and claims which follow, the word “comprise” and variations thereof, such as, “comprises” and “comprising” are to be construed in an open, inclusive sense, that is as “including, but not limited to.”

Reference throughout this specification to “one embodiment” or “an embodiment” means that a particular feature, structure, or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The headings provided herein are for convenience only and do not interpret the scope or meaning of the embodiments.

As an overview, embodiments of systems and methods for communicating with RFID tags located inside enclosures are provided. The enclosures have dimensions and/or material compositions such that normal communication with RFID tags located therein would be difficult or impossible. Therefore, embodiments place an antenna system inside of an enclosure, such that an internal or external RFID reader can use the antenna system to send signals to and receive signals from the RFID tags located inside the enclosure. Examples of the enclosures can include shipping containers, buildings, and vehicles. Examples of the antenna systems can include antenna arrays, wire antennas, radiating coaxial cables, waveguides with radiating apertures, and other types of antenna systems.

FIG. 1 shows an embodiment of a system 100 for identifying or otherwise reading RFID tags 102 inside a large enclosure 104. The RFID tags 102 may be active (i.e., including discrete power source) or passive (i.e., relying on interrogation beam for deriving power). The RFID tags 102 typically act as transponders, transmitting responses (to an interrogation signal) that encode information or data stored in memories of the RFID tag 102. Some of the RFID tags 102 may also be written to, and may employ security measures and/or encryption techniques. The structure and method of operation of the RFID tags 102, as well as RFID interrogators and other RFID readers are well known in the art and need not be discussed here further.

The enclosure 104, in this example, has physical dimensions that would normally exceed the range at which individual RFID tags 102 can be read. That is, the RFID tags 102 may be attached to various objects located (widely dispersed) within a warehouse, container, or other large enclosure 104, in such a manner that an RFID reader needs to be physically carried by a user to a reading position near each object (e.g., within a typical 20-foot range of a passive RFID tag), and/or the objects having the RFID tags 102 need to be repositioned (such as by conveyor belt, physically carrying, vehicle like a forklift, etc.) proximate to the RFID reader so as to be placed within reading range.

However, under some circumstances, repositioning objects having the RFID tags 102 and/or moving an RFID reader within the enclosure 104 may not be practical or physically possible. For instance, the objects having the RFID tags 102 may be heavy or bulky, or may be crated or stacked in pallets or may be stored on shelves. In other situations, for example, an RFID reader may require a wired connection (e.g., to a wall outlet) to receive power (and therefore cannot be moved great distances) to read RFID tags 102, or a user may not have sufficient reach or equipment (e.g., a ladder) to read a particular RFID tag 102 located towards the top of stacked pallets.

Therefore, an embodiment of the system 100 of FIG. 1 allows the objects having the RFID tags 102 to remain stationary for reading, without requiring the objects and/or an RFID reader 106 to be repositioned or otherwise moved into reading range. To provide this capability, the system 100 implements an internal extended antenna system 108, which is communicatively coupled to one or more RFID readers 106 and which is distinct and separate from the RFID reader 106. In operation, the RFID reader 106 transmits interrogation signals to the antenna system 108, which then relays the interrogation signals to target RFID tags 102. In response, the target RFID tags transmit return signals (having data encoded thereon), which are received by the antenna system 108 and relayed back to the RFID reader 106 for decoding and/or processing.

The antenna system 108 of an embodiment is configured such that segments of the antenna system 108 can send interrogation signals to and pick up return signals from multiple RFID tags 102 inside the enclosure 104. For example, the segments of the antenna system 108 can comprise omni-directional antennas and/or directional antennas. An example of an omni-directional antenna that can be used in an embodiment is a leaky coaxial cable, a wire antenna, a waveguide with radiating apertures, or other type of antenna.

The design (e.g., type and layout) of the antenna system 108 can be based on the size and shape of the enclosure 104, as well as on the known or expected the location of the RFID tags 102 within the enclosure 104. For example, if more RFID tags 12 are located in a first region inside the enclosure 104, as compared to a second region, then a greater concentration of segments (e.g., omni-directional antennas) of the antenna system 108 may be located near the first region instead of the second region, so as to ensure adequate transmission and reception of signals in the first region. Alternatively or additionally, directional antennas of the antenna system 108 can be oriented such that their radiating field is directed more generally towards the first region rather than the second region.

According to various embodiments, the antenna system 108 can be installed permanently or temporarily deployed within the enclosure 104. Permanent installment can involve stapling, nailing, strapping, or other suitable attachment to internal structures (e.g., beams, walls, ceilings, etc.) of the enclosure 104. Temporary installment can involve taping, hanging off hooks, laying, or other removable installation on the internal structures. Whether permanently or temporarily installed, the antenna system 108 can be deployed in a manner that accommodates the contours or other physical features of the internal structures of the enclosure 104. For instance, segments of the antenna system 108 can be drilled through, wrapped over, hung from, or run/attached alongside ceiling beams of the enclosure 104.

In one embodiment, segments of the antenna system 108 can be selectively controlled. For example, a first segment of the antenna system 108 in a first region of the enclosure 104 can be activated to read RFID tags 102 in the first region. Then, the first segment is deactivated, and a second segment of the antenna system 108 in a second region of the enclosure 104 can be activated to read RFID tags in the second region, and so forth. By appropriately laying out segments of the antenna system 108 within identified regions within the enclosure 104, the system 100 can identify the presence and content of the RFID tags 102 throughout the interior of the enclosure 104.

According to an embodiment, the antenna system 108 is coupled to a single RFID reader 106. In this embodiment, therefore, capability is provided for reading all of the RFID tags 102 inside the enclosure 104 from a single RFID reader location.

The RFID reader 106 may be located inside or outside of the enclosure 104. For example, if located inside the enclosure 104, the RFID reader 106 can be wired or wirelessly coupled to the antenna system 108. If located outside the enclosure 104, the RFID reader can be coupled to the antenna system 108 via a hardwire coupling, such as a hardwire connection through an aperture of the enclosure 104, or wirelessly coupled to the antenna system 104 with the use of intermediate devices between the antenna system 104 and the RFID reader 106, as will be described with other embodiments below.

In another embodiment, multiple RFID readers 106 may be provided inside and/or outside of the enclosure 104. Use of multiple RFID readers 106 allows the RFID-reading tasks to be distributed between multiple RFID readers (such as if different segments of the antenna system 108 are used to read RFID tags 102 located in different regions of the enclosure 104), and/or allows one or more RFID readers 106 to serve as backups.

One or more coupling devices 110 can be coupled between the RFID reader 106 and the antenna system 108, and/or may be present within the antenna system 108. The coupling device 110 can include hardware and/or software to facilitate the communication of signals through the antenna system 108. For instance, the coupling device 110 can include amplification circuitry to ensure that an adequate level of signal is being sent to or received from the RFID tags 102. The coupling device 110 can also include filtering circuitry, switching circuitry (such as for selectively switching activation of different segments of the antenna system 108), signal reconstruction circuitry, or other circuitry. Other example embodiments of the coupling device 110 that can be used in the system 100 are disclosed in U.S. patent application Ser. No. 11/172,375, entitled “APPARATUS AND METHOD TO FACILITATE WIRELESS COMMUNICATIONS OF AUTOMATIC DATA COLLECTION DEVICES IN POTENTIALLY HAZARDOUS ENVIRONMENTS,” filed Jun. 30, 2005, assigned to the same assignee as the present application, and incorporated herein by reference in its entirety.

In an embodiment, multiple-RFID-tag protocols and techniques can be used to identify individual or groups of RFID tags 102 inside the enclosure 104. Example multiple-RFID-tag identification protocols that can be used by an embodiment of the system 100 (as well as other systems described herein) are disclosed in U.S. Pat. Nos. 5,673,037 and 5,828,318, which are incorporated by reference in their entireties.

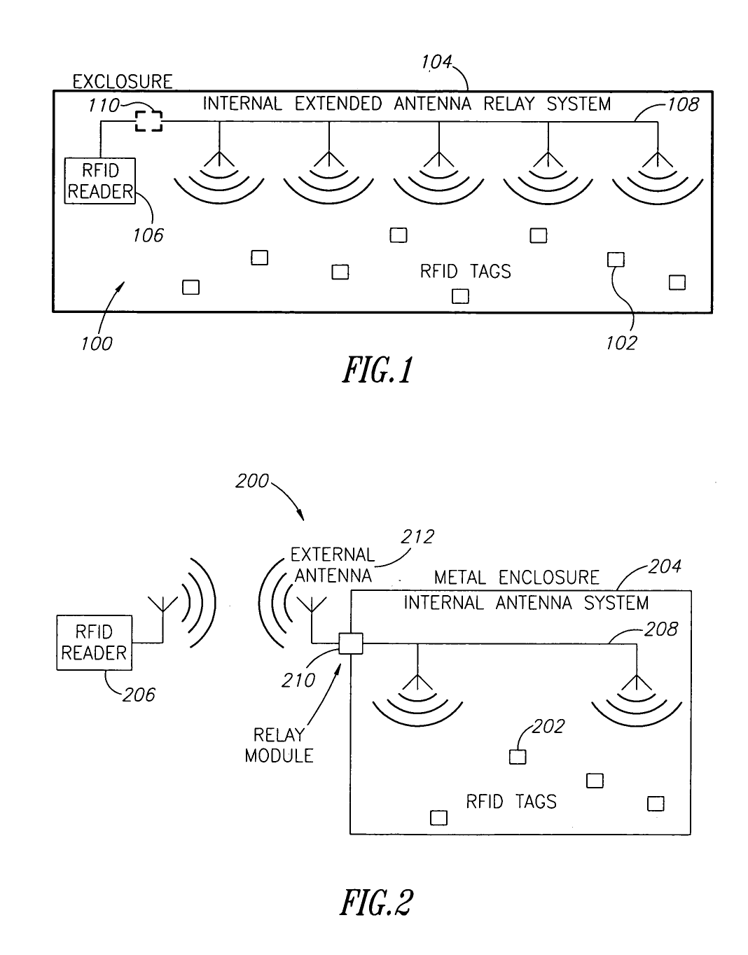

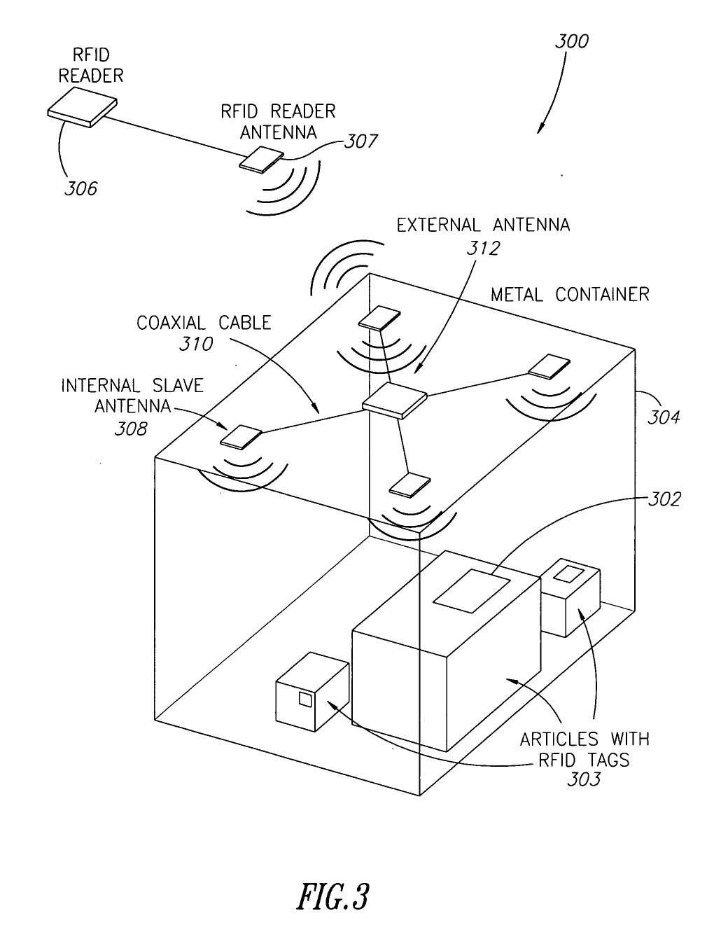

FIG. 2 shows an embodiment of a system 200 for communicating with RFID tags 202 inside a metal enclosure 204. The metal enclosure 202 can comprise, for example, a shipping container, trailer, building, or other enclosure that substantially blocks or otherwise adversely affects the transmission and reception of RF signals through its walls. The surfaces of the metal enclosure 202 can include, for example, a metal walls or a metal grid, such as a wire mesh with openings of small electrical length.

As with the system 100 of FIG. 1, the embodiment of the system 200 of FIG. 2 uses an internal antenna system 208 to relay signals to and from the RFID tags 202 located inside the enclosure 202. An embodiment of the antenna system 208 can use similar types, configuration, or layouts of antenna segments as the embodiments described above with reference to FIG. 1, and for the sake of brevity, will not be described again herein.

In an embodiment of the system 200, a relay module 210 or other coupling device communicatively couples the internal antenna system 208 to one or more external antennas 212. For example, an opening may be cut or formed in a wall of the enclosure 204 to accommodate the relay module 210 or connections thereto. The external antenna 212 and relay module 210 allows signals to be communicated to and from the internal antenna system 208, which signals may otherwise be blocked by the metallic walls of the enclosure 204.

The relay module 210 of an embodiment includes transceiver circuitry to wirelessly communicate signals received by the antenna system 208 from the RFID tags 202 to one or more RFID readers 206 located externally to the enclosure 204. Alternatively or additionally, the relay module 210 can communicate such signals to the RFID reader(s) 206 via a hardwire connection.

The relay module 210 also operates to convey signals (such as interrogation signals) received from the RFID reader 206 by the external antenna 212 to the RFID tags 202. The relay module 210 can also operate to convey other types of signals, such as control signals, to selectively activate and deactivate various segments of the antenna system 208.

The relay module 210 of an embodiment can include additional circuitry to support operation of the antenna system 208. Examples of such circuitry include filtering, signal reconstruction, control, switching, or other circuitry, including those described above with reference to the embodiment of FIG. 1.

FIG. 3 shows an embodiment of a system 300 for reading RFID tags 302 located inside a metal enclosure 304. The system 300, for instance, can comprise one example implementation of the system 200 of FIG. 2 for inspecting articles 303 (having RFID tags 32 attached thereto) carried in a metal shipping container.

An embodiment of the system 300 comprises a plurality of slave antennas 308 placed inside of the enclosure 304 and oriented in such a manner so as to optimally read the RFID tags 302. The slave antennas 308 are communicatively coupled to one or more external antennas 312 located on the outside surface of the enclosure 304. Coaxial cables 310 or other suitable hardwire links can be used to couple the slave antennas 308 to the external antenna(s) 312. Wireless links may also be used.

The external antenna 312 of an embodiment comprises a high-gain antenna array that transmits encoded signals from the RFID tags 302 received by the slave antennas 308 to one or more RFID reader antennas 307 placed some distance away from the enclosure 304. The RFID reader antenna 307 is in turn wired and/or wirelessly coupled to one or more corresponding RFID readers 306. The external antenna 312 also operates to convey signals, such as interrogation signals, received from the RFID reader 306 to one or more of the RFID tags 302, via appropriate ones of the slave antennas 308.

The configuration and the number of slave antennas 308 to be used for the system 300 may be determined based at least in part on the size of the enclosure 304 and the expected number of RFID tags, so that all of the RFID tags inside the enclosure 304 can be reliably read. The location and number of components (e.g., slave antennas 308, external antenna 312, and RFID reader antenna 307) can be dependent on the particular application. For example, fewer components may be required for enclosures 304 having a relatively small size.

Each slave antenna 308 of the system 300 can comprise a sub-array in an embodiment. The complexity of the design of the external antenna 312 can be increased with the electrical size of the enclosure 304. For larger enclosures 304, for example, the RFID reader antenna 307 (and/or some other antenna, such as a base station antenna) can be located above the external antenna 312 at a shorter distance. Alternatively or additionally, the RFID reader antenna 307 and/or the base station antenna can be sufficiently sensitive to detect the RFID tags 308. A consideration associated with placing the interrogating RFID reader antenna 307 and/or base station antenna closer to the external antenna 312 is that the effective field of the external antenna 312 would occupy a smaller region of the read zone diverging from the position of the external antenna 312. This factor is one consideration as the size of the enclosure 304 increases, due to the fact that the gain of the external antenna 312 has to be increased to enhance the probability of detection. However, for small enclosure 304, this factor may have less of an influence. For example, an enclosure 304 can have one slave antenna inside and a similar master antenna outside the enclosure 304. Such a configuration may have a wider angular read zone for the RFID reader antenna 307 and/or a base station antenna.

The coaxial cables 310 or other type of conductors provide electrically conducting RF paths that lead from the external antenna 312 at the exterior of the enclosure 304, through a suitable aperture or apertures (e.g., in the top wall of the enclosure 304), and along the interior wall surface to the respective slave antennas 308. It is appreciated that the illustrated placement of the slave antennas 308, the illustrated location of the external antenna 312, and the placement of the RFID reader antenna 307 (or some other antenna, such as a base station antenna) above the enclosure 304 is by way of example only in FIG. 3.

The multiple RFID tags 302 inside the enclosure 304 may each have unique identifiers. The external antenna 312 of the system 300 may be highly sensitive to the response signals (radiated from the RFID tags 302) that are relayed to the external antenna 312 from the slave antennas 308 via the coaxial cables 310. The entire system 300 of one embodiment is designed such that the signals supplied from the slave antennas 308 to the external antenna 312 via the respective coaxial cables 310 are combined at the external antenna 312, so as to cause the resultant RF field radiated from the external antenna 312 to correspond to the response that would be obtained if each of the RFID tags 308 were located in the direct interrogation field of the RFID reader antenna 307.

In an embodiment, the RFID reader 306 could be associated with a workstation at a fixed location to which the enclosure 304 is moved, or the RFID reader 306 could be part of a hand-held or vehicle-mounted system or other portable system that could be moved to obtain maximum signal from the external antenna 312. The workstation can comprise a personal computer (PC), a terminal or other portion of a host computing system, or other device usable to process the data decoded from the signals provided by the external antenna 312. The vehicle-mounted or portable system can comprise, for example, a vehicle having the RFID reader 306 that is driven between locations of various stationary enclosures 304 to read the RFID tags present therein.

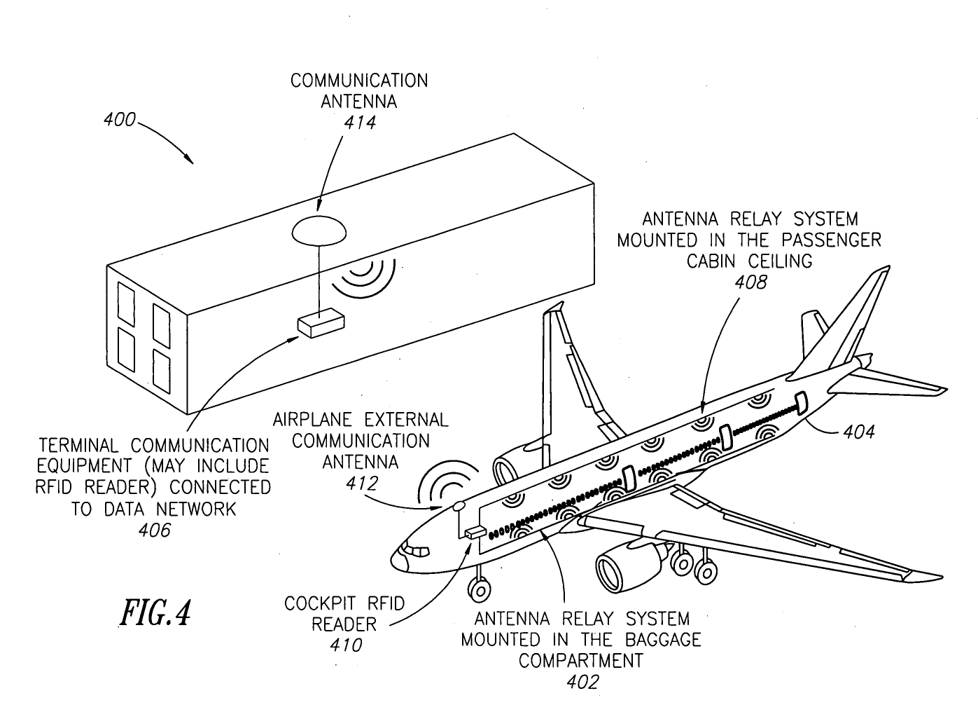

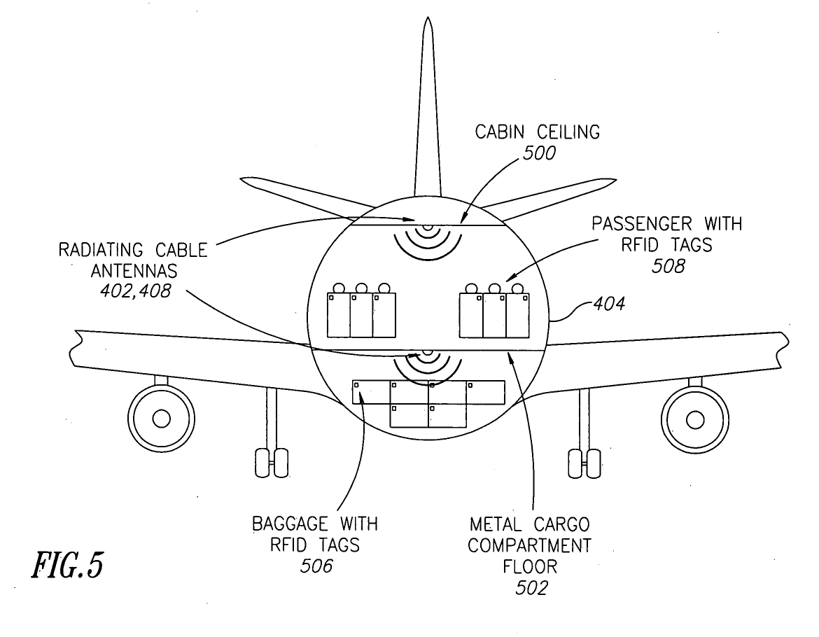

FIGS. 4-5 show another example implementation for reading RFID tags inside enclosures, and more particularly, an embodiment of a system 400 for tracking RFID tags inside a vehicle, such as an airplane. In the specific example of FIGS. 4-5, the system 400 is used to identify and track airplane passengers and baggage. Embodiments of systems similar to the system 400 can also be used to identify and track passengers and baggage in buses, trains, ferry boats, or other transportation vehicles.

The airplane of FIGS. 4-5 comprises an external enclosure 404 generally made of aluminum or other lightweight metal. Inside the enclosure 404, there may be other structures (see, e.g., FIG. 5), such as a cabin ceiling 500 and a metal compartment floor 502 to separate the main cabin from the baggage compartment. In a typical situation, the enclosure 404, the cabin ceiling 500, and/or the compartment floor 502 may block RF signals from, for example, external antennas that may be located outside of the enclosure 404. Moreover, the length of the enclosure 404 may greatly exceed the reading range of RFID tags.

Therefore, an embodiment of the system 400 provides the capability to detect and identify objects (having RFID tags attached thereto) inside of the enclosure 404. Possible examples of objects with RFID tags inside of an airplane can include passenger identification cards and tickets, baggage and cargo items, individual lifesaving equipment (such as lifejackets, masks, etc.), and others. Once the presence of RFID tags is detected, certain pieces of useful information can be obtained from the RFID tags, including number, identity, and immigration status of passengers on board, information about the baggage items on board, number of lifesaving equipment pieces on board, and other examples.

The information obtained from the RFID tags can be used to, for example, efficiently organize the operation of the airport facilities and the airplane, enhance security measures by identifying potentially suspect passengers and baggage items, confirm the availability of lifesaving equipment for each passenger, confirm whether there may be additional seats available in the airplane, and so on. In yet another example, each individual piece of baggage may be matched to specific passengers, where on-board baggage and passengers are detected through their RFID tags—if an unmatched piece of baggage is detected on board the airplane, a potential security breach may be thus identified for appropriate action.

In one embodiment, using RFID tags in combination with sensors provides additional application opportunities, such as determining (using an RFID tag combined with an accelerometer) whether any RFID-tagged items have been moved or removed during the flight. In another embodiment, determination of whether an RFID-tagged item has moved can be performed by identifying the item using a first antenna system located at a first location of the enclosure, and then later identifying the same item using a second antenna system located at a second location of the enclosure different than the first enclosure.

To provide such capabilities, an embodiment of the system 400 includes a first antenna relay system 402 placed in the baggage compartment and a second antenna relay system 408 placed in the passenger cabin. As shown in FIG. 5, the first antenna relay system 402 can be used to read RFID tags attached to baggage items 506 present in the baggage compartment, while the second antenna system 408 can be used to read RFID tags associated with passengers 508 present in the passenger cabin.

In an embodiment, the first antenna relay system 402 and the second antenna relay system 408 comprise antenna segments extended along the length of the airplane, as shown in FIG. 4. The antenna segments can be permanently or temporarily affixed to internal structures of the airplane, such as the attachment to the compartment floor 502 and to the cabin ceiling 500.

Examples of permanent attachment include use of a radiating cable antenna (e.g., leaky coaxial cable) permanently installed under the compartment floor 502 so as to radiate RF over and towards the baggage items 506 and installed on the cabin ceiling 500 so as to radiate RF over and towards the passengers 508. Alternatively or additionally to coaxial cable, a suitable UHF radiating cable, a wire antenna, a waveguide with radiating apertures, or other type of antenna may be used. Whichever type of antenna is used, the appropriate measures may be taken to ensure that the signals from the antennas do not interfere with instrumentation of the airplane.

One example of a temporary antenna system includes a wire unrolled and stretched in the air inside the length of the passenger cabin. Therefore, such a wire acts as a center conductor and forms a hollow coaxial cable with the walls of the passenger cabin (i.e., forms a hollow coaxial cable with the enclosure 404). Another example of a temporary antenna system uses a cart (such as a refreshment cart used by flight attendants) having omni-directional antennas mounted thereon. The cart can be rolled down the aisle of the passenger cabin in order to read RFID tags of passengers 508.

In an embodiment, the first antenna relay system 402 and/or the second antenna relay system 408 can be communicatively coupled to an RFID reader 410 located in the cockpit of the airplane. With this embodiment, crew members can perform the reading of the RFID tags in the passenger compartment and in the baggage compartment before takeoff, during the flight, and after landing to confirm that all passengers 508 and baggage items 606 have been accounted for. The system 400 can include other components, such as those in described above with regards to the coupling device 110 in FIG. 1 and the relay module 210 in FIG. 2, to support operation of the system 400. For example, such components can include amplifiers, filters, switches, and other circuitry to enhance the quality of the RF signals being communicated and/or to prevent or limit interference with the airplane's instrumentation.

In one embodiment of the system 400, the first antenna relay system 402 and/or the second antenna relay system 408 can be communicatively coupled to a communication antenna 412 located on an external surface of the enclosure 404. The communication antenna 412 of one embodiment comprises an antenna that is already present in most airplanes for communicating with ground facilities.

Therefore in an embodiment, the communication antenna 412 can exchange signals with a communication antenna 414 located at an airport terminal. The communication antenna 414 is in turn coupled to terminal communications equipment 406 that includes one or more RFID readers communicatively coupled to a data network. Accordingly, airport personnel at the airport terminal can identify and track the baggage items 506 and the passengers 508 inside the airplane, alternatively or additionally to identification and tracking by crew members inside the airplane.

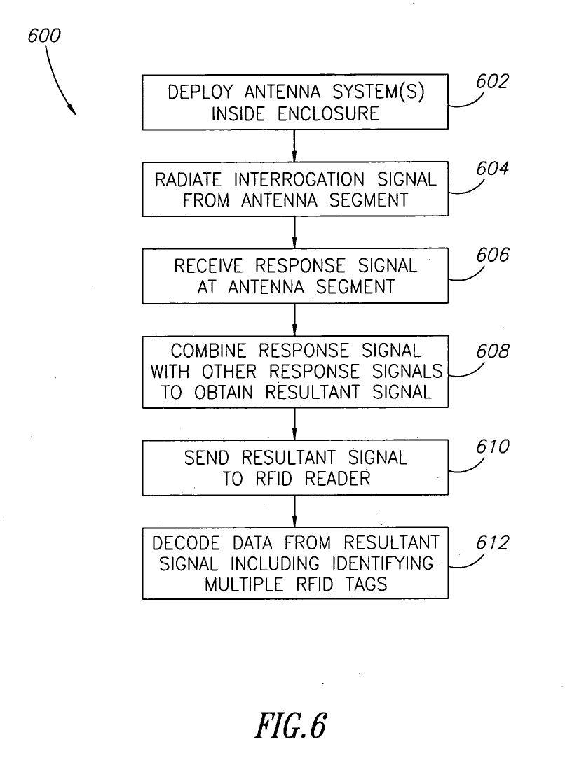

FIG. 6 is a flow diagram of a method 600 to use one or more antenna systems to read RFID tags inside an enclosure. In an embodiment, some of the operations depicted in the method 600 can be implemented through software or other machine-readable instructions executable by a processor and stored on a machine-readable storage medium. The processor and storage medium can be implemented, for example, in the RFID reader 106 of FIG. 1, in the RFID reader 206 of FIG. 2, in the RFID reader 306 of FIG. 3, in the RFID reader 410 and/or the terminal communications equipment 406 of FIG. 4. It is appreciated certain operations in the flow diagram 600 need not necessarily be performed in the exact order shown, and that certain operations can be suitably added, removed, combined, or modified.

At a block 602, one or more antenna systems (and associated components) are deployed permanently or temporarily inside of an enclosure. For example, the antenna system 108 is deployed inside the large enclosure 104 in FIG. 1, the antenna system 208 is deployed inside the metal enclosure 204 in FIG. 2 along with the external antenna 212 and relay module 210, the slave antennas 308 are deployed inside the metal enclosure 304 of FIG. 3 along with the external antenna 312, the antenna relay systems 402 and 408 are deployed inside the airplane of FIGS. 4-5, and so forth.

At a block 604, when objects in the enclosure having RFID tags are to be read, an interrogation signal is radiated from an antenna segment (such as from a slave antenna in FIG. 3). In one embodiment, an interrogation signal is progressively radiated from (and corresponding response signals are received at) one antenna segment to another antenna segment, such as by selective activation of antenna segments by transmitting interrogation signals from the antenna segments. In another embodiment, the interrogation signals may be radiated concurrently from various different antenna segments.

At a block 608, the response signals from each of the antenna segments are combined to obtain a resultant signal, which is then sent to an RFID reader at a block 610. For example, in the embodiment of FIG. 3, the response signals received by each of the slave antennas 308 are combined together at the external antenna 312 and transmitted to the RFID reader 306. In another embodiment, the response signals from the various antenna segments can be separately conveyed as resultant signals to an RFID reader at blocks 608 and 610, without necessarily undergoing a signal combination process.

At the block 610, the resultant signal may be sent to an RFID reader located within an enclosure, via a hardwire connection, such as described above with respect to the embodiment of FIG. 1 and with respect to the cockpit RFID reader 410 in FIG. 4. In other embodiments, such as those shown in FIGS. 2-5, an external antenna can wirelessly convey the resultant signal to an RFID reader located some distance from the enclosure.

At a block 612, data encoded in the resultant signal is decoded to obtain the information stored by the RFID tags. This decoding can be performed by an RFID reader and/or by a host computing system coupled thereto. In an embodiment, multiple-RFID-tag identification protocols may be used at the block 612 to identify the presence and content of multiple RFID tags that are interrogated by an interrogation having a wide dispersion.

All of the above U.S. patents, U.S. patent application publications, U.S. patent applications, foreign patents, foreign patent applications and non-patent publications referred to in this specification and/or listed in the Application Data Sheet, are incorporated herein by reference, in their entirety.

The above description of illustrated embodiments, including what is described in the Abstract, is not intended to be exhaustive or to limit the invention to the precise forms disclosed. While specific embodiments and examples are described herein for illustrative purposes, various equivalent modifications are possible within the scope of the invention and can be made without deviating from the spirit and scope of the invention.

For example, various embodiments have been described above using hardwire antenna segments for the various antenna systems. In other embodiments, some or all of these segments of the antenna systems can be replaced with wireless links. For instance, wireless transceivers can be communicatively coupled to one another inside an enclosure so as to convey wireless interrogation signals and corresponding return signals from one point to another within an enclosure.

These and other modifications can be made to the embodiments in light of the above detailed description. The terms used in the following claims should not be construed to limit the invention to the specific embodiments disclosed in the specification and the claims. Rather, the scope of the invention is to be determined entirely by the following claims, which are to be construed in accordance with established doctrines of claim interpretation.

What is claimed is:

1. A system for an enclosure to contain a plurality of wireless data carriers, the system comprising:
an antenna system extended within the enclosure to send a wireless interrogation signal to and to receive corresponding wireless response signals from at least some of the data carriers that are located within a communication range from the antenna system; and
an automatic data collection device having an antenna that is separate and distinct from the antenna system, the data collection device being communicatively coupled to the antenna system to generate the interrogation signal sent by the antenna system and to process the response signals received by the antenna system.

2. The system of claim 1 wherein the wireless data carriers comprise radio frequency identification (RFID) tags, and wherein the automatic data collection device comprises an RFID reader.

3. The system of claim 1 wherein the enclosure has physical dimensions greater than a communication range between the automatic data collection device and at least an individual one of the data carriers, absent the antenna system.

4. The system of claim 1 wherein the antenna system comprises a plurality of separately controllable antenna segments located in different regions of the enclosure, each antenna segment being capable to facilitate communications with data carriers in respectively located in the different regions of the enclosure.

5. The system of claim 1, further comprising a coupling module coupled between the antenna system and the automatic data collection device to enhance communication between the data carriers and the automatic data collection device.

6. The system of claim 5 wherein the automatic data collection device is located external to the enclosure and is communicatively coupled to the antenna system via hardwire connection in the coupling module.

7. The system of claim 5 wherein the automatic data collection device is located within the enclosure and is communicatively coupled to the antenna system via hardwire connection between the data collection device and the antenna system.

8. The system of claim 1 wherein the antenna system comprises a plurality of slave antennas located inside the enclosure, the system further comprising:
at least one master antenna located outside of the enclosure and communicatively coupled to the slave antennas, the master antenna being capable to generate a resultant signal representative of the response signals from the data carriers that can be received by the antenna of the automatic data collection device; and
a host computing system coupled to the automatic data collection device to process data encoded in the resultant signal received by the antenna of the data collection device.

9. The system of claim 1 wherein at least part of the enclosure is made from a metal material.

10. The system of claim 1 wherein the enclosure comprises at least one of a building section, shipping container, or transportation vehicle.

11. The system of claim 1 wherein the enclosure comprises part of a housing of a vehicle that can carry baggage items and passengers, the housing of the vehicle defining a passenger compartment and a baggage compartment, wherein the antenna system includes:
a first antenna relay system extending within the baggage compartment at least in part along a length of the vehicle, the first antenna system being usable to send interrogation signals to and to receive corresponding response signals from data carriers associated with the baggage items; and
a second antenna relay system extending within the passenger compartment at least in part along a length of the vehicle, the second antenna system being usable to send interrogation signals to and to receive corresponding response signals from data carriers associated with the passengers of the vehicle or with objects in the passenger compartment.

12. The system of claim 11 wherein the automatic data collection device is located at a crew member compartment of the vehicle and is communicatively coupled to the first and second antenna relay systems.

13. The system of claim 11, further comprising:
a first external antenna located on an outside surface of the vehicle and communicatively coupled to the antenna system;
a second external antenna located remotely from the vehicle; and
communications equipment coupled to the second external antenna to generate additional interrogation signals to be conveyed to the data carriers by way of the second and first external antennas and the antenna system, and to process response signals that are sent from the data carriers in response to the additional interrogation signals and that are conveyed by way of the antenna system and the first and second external antennas.

14. The system of claim 11 wherein the second antenna system can be portably moved within the passenger compartment.

15. The system of claim 11 wherein the data carriers associated with the passengers or with objects in the passenger compartment are attached to lifesaving equipment, passenger identification documents, tickets, and immigration documents.

16. The system of claim 1 wherein the antenna system comprises an antenna array, a wire antenna, a radiating coaxial cable, or a waveguide with radiating apertures.

17. A system, comprising:
an enclosure defining an internal compartment that can contain objects having a plurality of wireless data carriers; and
an antenna system deployed in the internal compartment to send wireless interrogation signals, generated externally of the enclosure, to at least some of the data carriers and to receive corresponding wireless response signals from at least some of the data carriers, the antenna system including antenna segments having fields of coverage that cover respective regions in the internal compartment where the data carriers are located, in a manner that each antenna segment can send an interrogation signal to read the data carriers located in the respective regions within their respective fields of coverage.

18. The system of claim 17, further comprising an automatic data collection device communicatively coupled to the antenna system to externally generate the interrogation signals and to process the received corresponding response signals, the automatic data collection device having an antenna that is separate and distinct from the antenna system.

19. The system of claim 18, further comprising a first antenna located outside of the enclosure and coupled to the data collection device, the data collection device being remotely located outside of the enclosure and having a second antenna to receive a resultant signal sent by the first antenna that is representative of at least one response signal from the data carriers.

20. The system of claim 17 wherein the enclosure comprises a housing of a transportation vehicle, wherein the internal compartment comprises a passenger compartment and a baggage compartment, and wherein the antenna system includes:
a first antenna relay system extending within the baggage compartment at least in part along a length of the vehicle, the first antenna system being usable to send interrogation signals to and to receive corresponding response signals from data carriers associated with objects in the baggage compartment; and
a second antenna relay system extending within the passenger compartment at least in part along a length of the vehicle, the second antenna system being usable to send interrogation signals to and to receive corresponding response signals from data carriers associated with objects in the passenger compartment.

21. A method to read wireless data carriers associated with objects contained in an enclosure, the method comprising:
generating interrogation signals externally of the enclosure;
providing the generated interrogation signals to a hardwire connection to respective antenna portions of an antenna system located inside the enclosure to allow the antenna system to convey the interrogation signals to a plurality of objects having associated wireless data carriers that are located within reading ranges of the respective antenna portions;
obtaining at least one resultant signal that is derived from wireless response signals generated by the wireless data carriers and received by respective antenna portions, and providing the resultant signal externally to the enclosure; and
processing the resultant signal to determine presence and content of the data carriers located within the reading ranges of the respective antenna portions.

22. The method of claim 21 wherein obtaining at least one resultant signal comprises combining the response signals to obtain a single resultant signal.

23. The method of claim 21 wherein obtaining at least one resultant signal comprises separately generating a resultant signal from each response signal, the resultant signals each being indicative of the content of data carriers located in different internal regions of the enclosure that are within fields of coverage of respective antenna portions.

24. The method of claim 21 wherein processing the resultant signal includes processing the resultant signal to determine if an associated data carrier has changed locations within the enclosure.

25. A system for reading wireless data carriers associated with objects contained in an enclosure, the method comprising:
means for generating interrogation signals;
first antenna means for providing the generated interrogation signals;
second antenna means, separate and distinct from the first antenna means and located inside the enclosure, for conveying the interrogation signals provided by the first antenna means to different regions inside the enclosure to respectively read wireless data carriers associated with objects located at the different regions;
means for obtaining at least one resultant signal that is derived from wireless response signals generated by the wireless data carriers in response to the interrogation signals and conveyed using the internal antenna means; and
means for processing the resultant signal to determine presence and content of the data carriers located in the different regions inside the enclosure.

26. The system of claim 25 wherein the means for processing the resultant signal is located inside the enclosure.

27. The system of claim 25 wherein the first antenna means is coupled to the means for processing and is located outside of the enclosure.

28. The system of claim 25 wherein the means for processing the resultant signal is located remotely from the enclosure and is wirelessly linked to the internal antenna means.

29. The system of claim 25, further comprising means coupled to the internal antenna means for enhancing communication between the data carriers the means for generating the interrogation signals and the means for processing the resultant signal.
